(19) United States
(12) Patent Application Publication
(10) Pub. No.: US 2016/0209010 A1
(43) Pub. Date: Jul. 21, 2016

(54) ASSEMBLY STRUCTURE OF LIGHT UNIT

(71) Applicant: YU-SYUAN CHEN, New Taipei City (TW)

(72) Inventors: Tien-Lin WU, New Taipei City (TW); Chin-Hsin LEE, New Taipei City (TW); Shih-Ming CHEN, New Taipei City (TW)

(21) Appl. No.: 14/601,444

(22) Filed: Jan. 21, 2015

(51) Int. Cl. F21V 21/14; F21V 29/71; F21V 29/74

(52) U.S. Cl. CPC F21V 21/14; F21V 29/74; F21V 29/717

(57) ABSTRACT

In an assembly structure of a light unit, two supporting bases individually support two sides of a lighting device. An adjustment frame spans the supporting bases and includes two supporting arms and a supporting plate. The supporting arm has a first axial hole and plural first adjustment holes. The supporting base has a first throughhole and a first lockhole which is aligned to the first adjustment hole. A first fastener passes the first throughhole and is fastened to the first axial hole. An adjustment plate has a second axial hole and plural second adjustment holes. A supporting plate has a second throughhole corresponding to the second axial hole and a second lockhole which is aligned to the second adjustment hole. A second fastener passes the second throughhole and is fastened to the second axial hole. Thus, a multi-angle adjustment of the light unit is made.

### BACKGROUND OF THE INVENTION

1. Field of the Invention

The present invention relates to a light unit and, in particular, to an assembly structure of a light unit.

2. Description of Related Art

The illumination angle and range of a traditional light unit are mostly fixed and cannot be adjusted according to the requirement of the installation place. Also, few light units which can adjust the illumination angle and range have the disadvantages of the complex adjustment structure and high manufacturing cost. Besides, even if the existing light unit can adjust the illumination angle, the illumination angle can only be adjusted in one direction; thus, a complete and full adjustment for illumination area is not available and the improvement thereof is required.

In view of foregoing, the inventor pays special attention to the above existing technology and researches with the application of related theory to overcome the above disadvantages regarding the above related art, which becomes the goal of the inventor's improvement.

### SUMMARY OF THE INVENTION

One objective of the present invention is to provide an assembly structure of a light unit, which can make a multi-direction adjustment in angle.

To achieve the above objective, the present invention provides an assembly structure of a light unit, which comprises a lighting device, a pair of supporting bases, an adjustment frame, a first fastener, an adjustment plate, and a second fastener. The lighting device comprises a light source and a heat-dissipation module thermally connecting to the light source. The pair of supporting bases individually support two opposite sides of the heat-dissipation module. The adjustment frame spans the pair of supporting bases and covers the lighting device. The adjustment frame comprises two supporting arms and a supporting plate connecting the two supporting arms. Each of the two supporting arms is provided with a first axial hole and a plurality of first adjustment holes circularly surrounding the first axial hole. Each of the pair of supporting bases is provided with a first throughhole corresponding to the first axial hole of the supporting arm and at least one first lockhole. The first lockhole can be selectively aligned with one of the first adjustment holes. The first fastener passes through the first throughhole and is fastened to the first axial hole. The adjustment plate is disposed on a side of the supporting plate away from the lighting device. The adjustment plate is provided with a second axial hole and a plurality of second adjustment holes circularly surrounding the second axial hole. The supporting plate is provided with a second throughhole corresponding to the second axial hole and at least one second lockhole. The second lockhole can be selectively aligned with one of the second adjustment holes. The second fastener passes through the second throughhole and is fastened to the second axial hole.

Another objective of the present invention is to provide an assembly structure of a light unit, which is provided with power racks disposed outside of the supporting bases. In this way, the power supplies can be directly placed in the power racks without finding other space to be placed, which improves convenience of assembly.

Compared with the prior art, the lighting device of the light unit of the present invention is fixed to the supporting bases. When the angles of the supporting bases change with respect to the adjustment frame, the lighting device will change the illumination angle following the movements of the supporting bases. Thus, the light unit performs the adjustment of the first direction by means of the adjustment frame and the supporting bases; also, when the angle of the adjustment frame changes with respect to the adjustment plate, the lighting device will also change the illumination angle at the same time following the movement of the adjustment frame. Thus, the light unit performs the adjustment of the second direction by means of the adjustment frame and the adjustment plate. Therefore, the light unit can perform the angle adjustment in two directions based on the practical demand to meet the requirements of the illumination angle and range and improve the practicability of the present invention.

### BRIEF DESCRIPTION OF DRAWING

FIG. 1 is a perspective schematic view of the light unit of the present invention;

FIG. 2 is a perspective exploded schematic view of the light unit of the present invention;

FIG. 3 is a schematic view of the light unit of the present invention in a locked state;

FIG. 4 is an adjustment schematic view of the assembly structure of the light unit of the present invention in a first direction;

FIG. 5 is an adjustment schematic view of the assembly structure of the light unit of the present invention in a second direction; and

FIG. 6 is a perspective schematic view of the light unit of the present invention after adjustment.

### DETAILED DESCRIPTION OF THE INVENTION

The detailed description and technical details of the present invention will be explained below with reference to accompanying figures. However, the accompanying figures are only for reference and explanation, but not to limit the scope of the present invention.

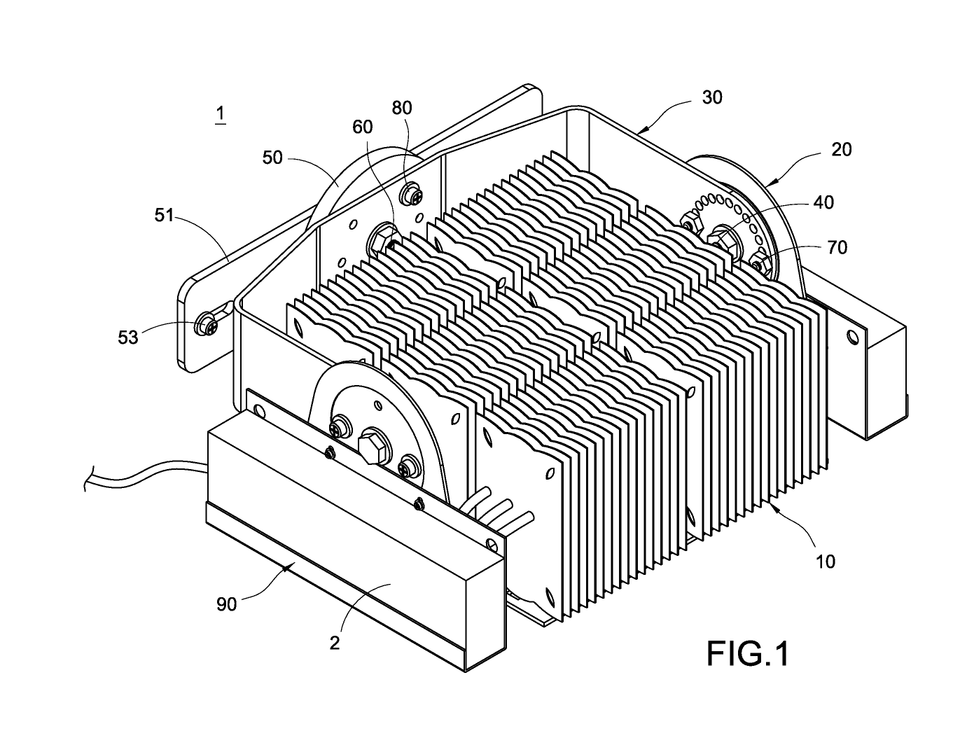

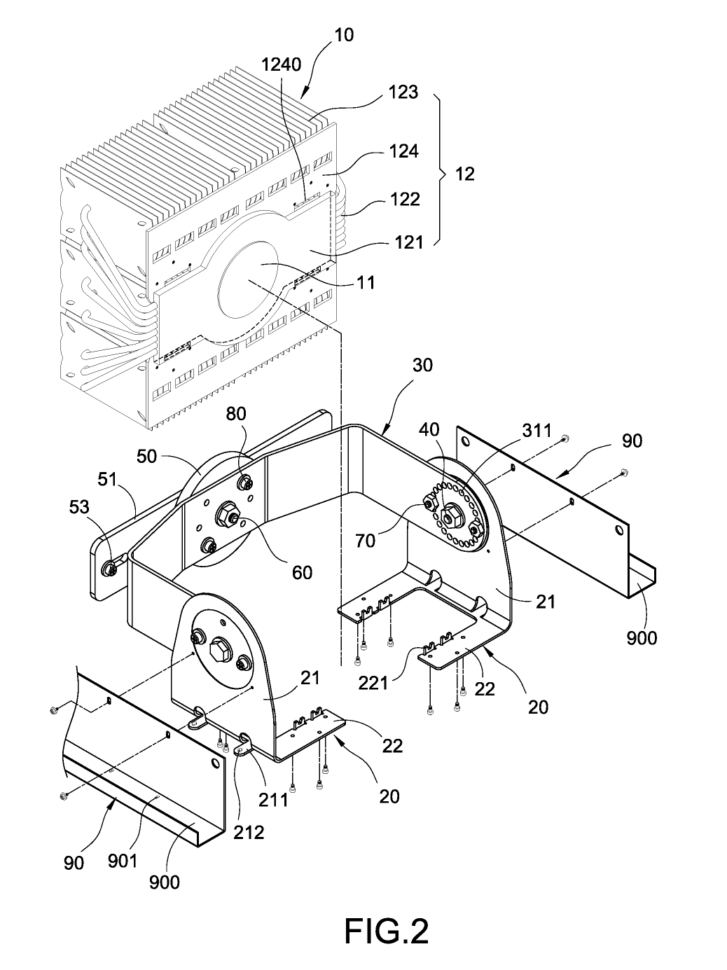

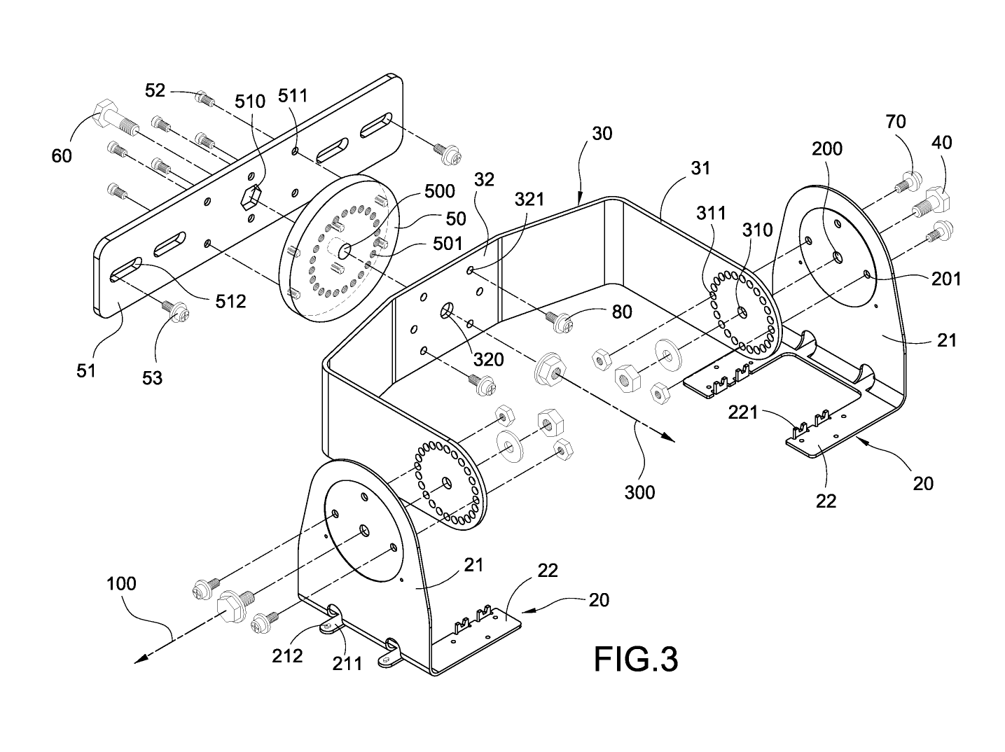

Please refer to FIGS. 1-3, which are a perspective schematic view, a perspective exploded schematic view of the light unit of the light unit of the present invention, and a schematic view of the light unit of the present invention in a locked state, respectively. The assembly structure of a light unit 1 of the present invention comprises a lighting device 10, a pair of supporting bases 20, an adjustment frame 30, a first fastener 40, an adjustment plate 50, and a second fastener 60. The lighting device 10 is locked between the pair of supporting bases 20 and the adjustment frame 30. Also, the lighting device 10 adjusts the illumination angle by means of the adjustment frame 30 and the adjustment plate 50.

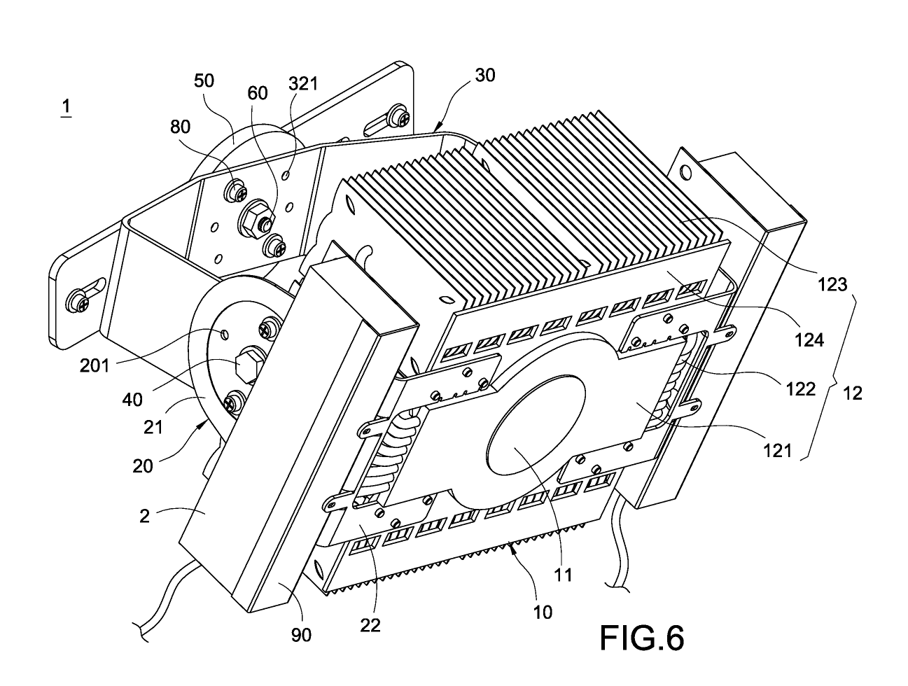

The lighting device 10 comprises a light source 11 and a heat-dissipation module 12 thermally connecting to the light source 11. In the current embodiment, the heat-dissipation module 12 comprises a heat-conduction plate 121 thermally connecting to the light source 11, a plurality of heat pipes 122 combined to the heat-conduction plate 121, a plurality of fins 123 connected to the heat pipes 122 in series, and a supporting plate 124 clamped between the heat-conduction plate 121 and the fins 123. In the current embodiment, the light source 11 is an LED light source, but not limited to this. Besides, the pair of supporting bases 20 individually support two opposite sides of the heat-dissipation module 12. In the current embodiment, the light source 11 is exposed between the pair of supporting bases 20 (please also refer to FIG. 6), but not limited to this.

The adjustment frame 30 spans the pair of supporting bases 20 and covers the lighting device 10. The adjustment frame 30 comprises two supporting arms 31 and a supporting plate 32 connecting the two supporting arms 31. Each of the two supporting arms 31 is provided with a first axial hole 310 and a plurality of first adjustment holes 311 circularly surrounding the first axial hole 310. Preferably, the first adjustment holes 311 are disposed surrounding the first axial hole 310 in a 360-degree arrangement.

Moreover, each of the pair of supporting bases 20 is provided with a first throughhole 200 corresponding to the first axial hole 310 of the supporting arm 31 and at least one first lockhole 201. The first lockhole 201 can be selectively aligned with one of the first adjustment holes 311. That is, the angle of the adjustment frame 30 with respect to the first direction 100 can be fixed by means of the alignment between the first adjustment hole 311 and the first lockhole 201. The first adjustment holes 311 of the left and right supporting arms 31 of the adjustment frame 30 will be individually aligned with the first lockholes 201 of the left and right supporting bases 20. At such an angle, the first fastener 40 is passed through the first throughhole 200 and is fastened to the first axial hole 310 such that the angle of the adjustment frame 30 with respect to the first direction 100 is fixed.

Preferably, the light unit 1 further comprises a plurality of first adjustment fasteners 70 and there are plural first lockholes 201. When the angle of the adjustment frame 30 with respect to the first direction 100 is fixed, the first lockholes 201 will be simultaneously aligned with the first adjustment holes 311 at different positions such that first adjustment fasteners 70 are individually fastened to the corresponding first lockhole 201 and the first adjustment hole 311 which are aligned to each other. In this way, a more stable combination between the adjustment frame 30 and the pair of the supporting bases 20 in the first direction 100 can be achieved.

Further, the adjustment plate 50 is disposed on a side of the supporting plate 32 away from the lighting device 10. The adjustment plate 50 is provided with a second axial hole 500 and a plurality of second adjustment holes 501 circularly surrounding the second axial hole 500. Preferably, the second adjustment holes 501 are disposed surrounding the second axial hole 500 in the 360-degree arrangement.

Besides, the supporting plate 32 of the adjustment frame 30 is provided with a second throughhole 320 corresponding to the second axial hole 500 and at least one second lockhole 321. The second lockhole 321 can be selectively aligned with one of the second adjustment holes 501. That is, the angle of the adjustment frame 30 with respect to the second direction 300 can be fixed by means of the alignment between the second adjustment holes 501 and the second lockhole 321. At such an angle, the second fastener 60 is passed through the second throughhole 320 and is fastened to the second axial hole 500 such that the angle of the adjustment frame 30 with respect to the second direction 300 is fixed.

Preferably, the light unit 1 further comprises a plurality of second adjustment fasteners 80 and there are plural second lockholes 321. When the angle of the adjustment frame 30 with respect to the second direction 300 is fixed, the second lockholes 321 will be simultaneously aligned with the second adjustment holes 501 at different positions such that second adjustment fasteners 80 are individually fastened to the corresponding second lockhole 321 and the second adjustment hole 501 which are aligned to each other. In this way, a more stable combination between the adjustment frame 30 and the pair of the supporting bases 20 in the second direction 300 can be achieved.

In more details, the adjustment frame 30 is a U-like frame. The two supporting arms 31 are formed symmetrically on two sides of the supporting plate 32. Also, the axial direction (i.e., the first direction 100) of the first axial hole 310 of the supporting arm 31 is vertical to the axial direction (i.e., the second direction 300) of the second throughhole 320.

The light unit 1 further comprises a pair of power frames 90 which are combined correspondingly to the outsides of the pair of supporting bases 20. In the current embodiment, the power frame 90 is an L-like frame and has a carrying space 900 to receive a power supply 2. Thus, the power supplies 2 can be directly placed in the power racks 90 without finding other space to be placed, which improves convenience of assembly. In the current embodiment, there are two power racks 90, which are individually placed the outsides of the pair of supporting bases 20.

It is worth noting that the outside of each of the pair of supporting bases 20 forms an ear 211 to which the power frame 90 is installed. Also, a positioning block 212 is disposed on a side of the ear 211 facing a side of the power frame 90; a positioning slot 901 is disposed correspondingly on a bottom side of the power frame 90. Thus, during the assembly of the power frames 90 and the pair of supporting bases 20, the positioning block 212 of the supporting base 20 can be positioned in the positioning slot 901 beforehand such that the supporting base 20 and the power frame 90 are temporarily positioned to each other to facilitate the assembly.

In an embodiment of the present invention, each of the pair of supporting bases 20 comprises a blocking pate 21 attached to the supporting arm 31 and two fixing pieces 22 extending vertically from a bottom edge of the blocking pate 21. The two fixing pieces 22 are fixed to the supporting plate 124. In this way, the lighting device 10 is combined with the pair of supporting bases 20 and the heat-conduction plate 121 is exposed between the fixing pieces 22 of the pair of supporting bases 20, which improves heat-dissipation efficiency.

Moreover, at least one positioning projection 221 is disposed at a side edge of each of the fixing pieces 22; the supporting plate 124 is correspondingly provided with a slot 1240 in which the positioning projection 221 is positioned. In this way, when the lighting device 10 is combined with the pair of supporting bases 20, the positioning projection 221 can be positioned in the slot 1240 beforehand such that the lighting device 10 and the supporting bases 20 are temporarily positioned to each other to facilitate the assembly.

In the current embodiment, the lighting device 10 further comprises a combination plate 51, a plurality of third fasteners 52, and a plurality of bolts 53. The combination plate 51 is locked to a side of the adjustment plate 50 away from the adjustment frame 30 by means of the third fasteners 52. Besides, the combination plate 51 is provided with a third throughhole 510 corresponding to the second axial hole 500 and is provided with a plurality of third lockholes 511 corresponding to the second adjustment holes 501. The third fasteners 52 pass through the third lockholes 511 and the second adjustment holes 501 to be locked to the second lockholes 321.

Regarding the above description, the combination plate 51 is further provided with a plurality of fixing holes 512. In this way, the light unit 1 is passed through the fixing holes 512 to be combined to a fixed position by means of the bolts 53.

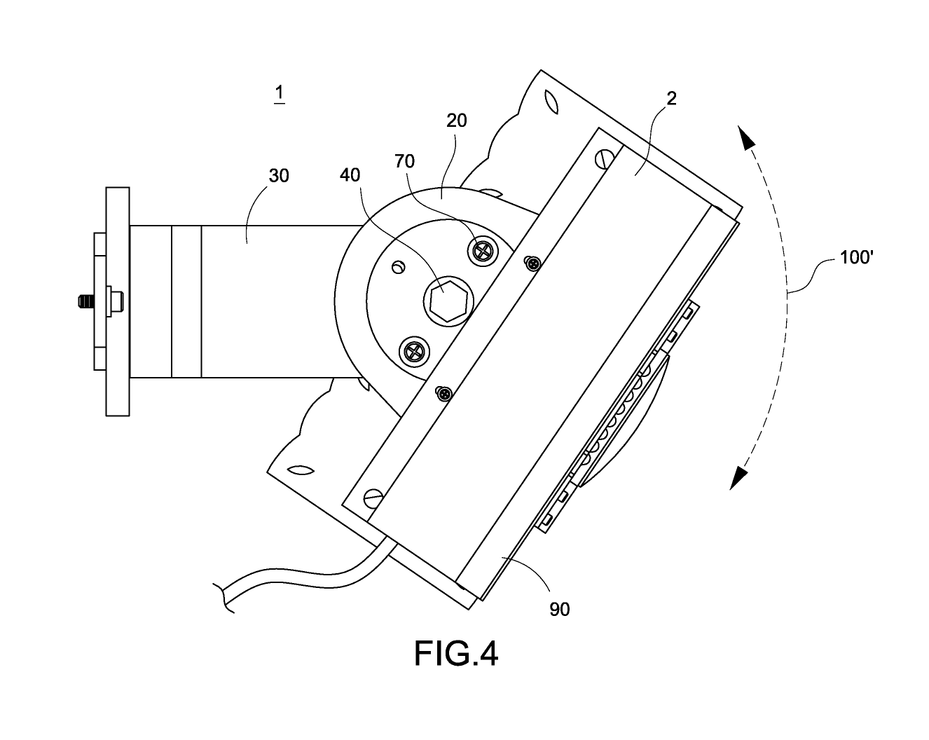

Please refer to FIGS. 4-6, which are the adjustment schematic views of the assembly structure of the light unit of the present invention in a first direction, in a second direction, and a perspective schematic view of the light unit of the present invention after adjustment, respectively. The light unit 1 of the present invention is combined to a fixed position by means of the combination plate 51. Also, the adjustment frame 30 is connected to the combination plate 51 by means of the adjustment plate 50; the light unit 1 is fixed to the pair of supporting bases 20. When the angles of the pair of supporting bases 20 change with respect to the adjustment frame 30 by means of the first fastener 40 and the first adjustment fasteners 70, the lighting device 10 will change the illumination angle following the movements of the supporting bases 20. In this way, the light unit 1 performs the first direction adjustment 100′, as shown in FIG. 4, by means of the adjustment frame 30 and the pair of supporting bases 20.

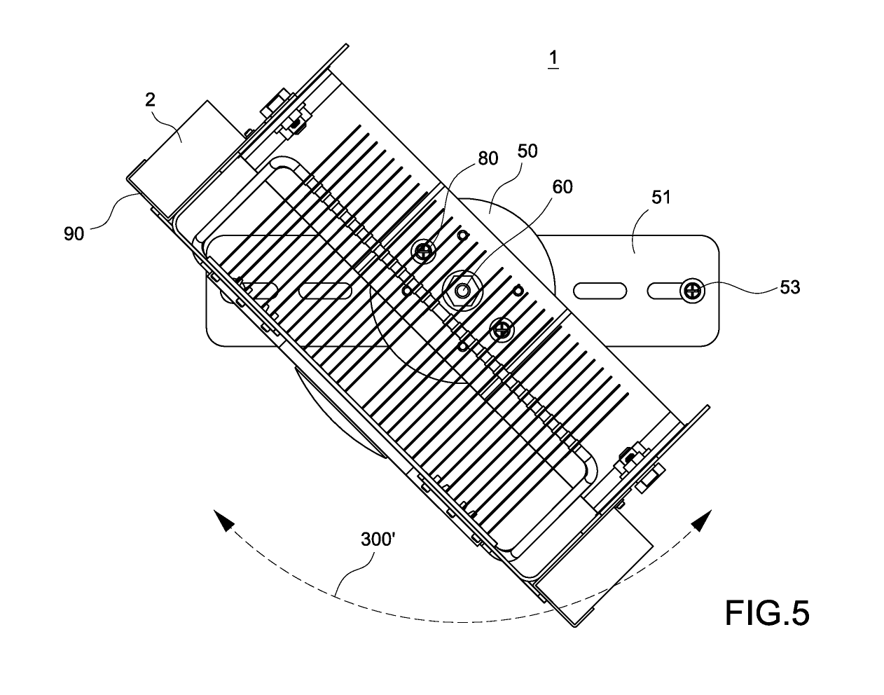

Besides, as shown in FIG. 5, when the angle of the adjustment frame 30 changes with respect to adjustment plate 50 by means of the second fastener 60 and the second adjustment fasteners 80, the lighting device 10 will simultaneously change the illumination angle following the movements of the adjustment frame 30. In this way, the light unit 1 performs the second direction adjustment 300′, as shown in FIG. 5, by means of the adjustment frame 30 and the adjustment plate 50.

As shown in FIG. 6, after the first direction adjustment 100′ and the second direction adjustment 300′ are performed according to the above description, the light unit 10 can perform an angle adjustment in two directions based on the practical demand to meet the requirements of illumination angle and range.

The embodiments disclosed above are only preferred embodiments of the present invention, but not to limit the present invention. All the equivalent modifications based on the spirit of the present invention should be covered by the scope of the present invention.

What is claimed is:

1. An assembly structure of a light unit (1), comprising:
a lighting device (10) comprising a light source (11) and a heat-dissipation module (12) thermally connecting to the light source (11);
a pair of supporting bases (20) individually supporting two opposite sides of the heat-dissipation module (12);
an adjustment frame (30) spanning the pair of supporting bases (20) and covering the lighting device (10), wherein the adjustment frame (30) comprises two supporting arms (31) and a supporting plate (32) connecting the two supporting arms (31), wherein each of the two supporting arms (31) is provided with a first axial hole (310) and a plurality of first adjustment holes (311) circularly surrounding the first axial hole (310), wherein each of the pair of supporting bases (20) is provided with a first throughhole (200) corresponding to the first axial hole (310) of the supporting arm (31) and at least one first lockhole (201), wherein the first lockhole (201) can be selectively aligned with one of the first adjustment holes (311);
a first fastener (40) passing through the first throughhole (200) and being fastened to the first axial hole (310);
an adjustment plate (50) disposed on a side of the supporting plate (32) away from the lighting device (10), wherein the adjustment plate (50) is provided with a second axial hole (500) and a plurality of second adjustment holes (501) circularly surrounding the second axial hole (500), wherein the supporting plate (32) is provided with a second throughhole (320) corresponding to the second axial hole (500) and at least one second lockhole (321), wherein the second lockhole (321) can be selectively aligned with one of the second adjustment holes (501); and
a second fastener (60) passing through the second throughhole (320) and being fastened to the second axial hole (500).

2. The assembly structure of the light unit (1) according to claim 1, further comprising a pair of power frames (90) which are combined correspondingly to outsides of the pair of supporting bases (20), wherein each of the pair of power frames (90) has a carrying space (900) to receive a power supply (2).

3. The assembly structure of the light unit (1) according to claim 2, wherein the outside of each of the pair of supporting bases (20) forms an ear (211) to which the power frame (90) is installed, wherein a positioning block (212) is disposed on a side of the ear (211) facing a side of the power frame (90), wherein a positioning slot (901) is disposed correspondingly on a bottom side of the power frame (90), wherein the positioning block (212) is positioned in the positioning slot (901).

4. The assembly structure of the light unit (1) according to claim 1, further comprising a plurality of first adjustment fasteners (70) and a plurality of second adjustment fasteners (80), wherein there are plural first lockholes (201) and plural second lockholes (321), wherein each of the first adjustment fasteners (70) is fastened to the corresponding first lockhole (201) and the first adjustment hole (311) which are aligned to each other, wherein each of the second adjustment fasteners (80) is fastened to the corresponding second lockhole (321) and the second adjustment hole (501) which are aligned to each other.

5. The assembly structure of the light unit (1) according to claim 1, wherein the heat-dissipation module (12) comprises a heat-conduction plate (121) thermally connecting to the light source (11), a plurality of heat pipes (122) combined to the heat-conduction plate (121), and a plurality of fins (123) connected to the heat pipes (122) in series.

6. The assembly structure of the light unit (1) according to claim 5, wherein each of the pair of supporting bases (20) comprises a blocking pate (21) attached to the supporting arm (31) and two fixing pieces (22) extending vertically from a bottom edge of the blocking pate (21), wherein the heat-dissipation module (12) further comprises a supporting plate (124) clamped between the heat-conduction plate (121) and the fins (123), wherein the two fixing pieces (22) are locked to the supporting plate (124), wherein the heat-conduction plate (121) is exposed between the fixing pieces (22) of the pair of supporting bases (20).

7. The assembly structure of the light unit (1) according to claim 6, wherein at least one positioning projection (221) is disposed at a side edge of each of the fixing pieces (22), wherein the supporting plate (124) is correspondingly provided with a slot (1240) in which the positioning projection (221) is positioned.

8. The assembly structure of the light unit (1) according to claim 1, wherein the adjustment frame (30) is a U-like frame, wherein the two supporting arms (31) are formed symmetrically on two sides of the supporting plate (32), wherein the axial direction of the first axial hole (310) of the supporting arm (31) is vertical to the axial direction of the second throughhole (320).

9. The assembly structure of the light unit (1) according to claim 1, wherein the first adjustment holes (311) are disposed surrounding the first axial hole (310) in a 360-degree arrangement, wherein the second adjustment holes (501) are disposed surrounding the second axial hole (500) in the 360-degree arrangement.

10. The assembly structure of the light unit (1) according to claim 1, further comprising a combination plate (51) and a plurality of third fasteners (52), wherein the combination plate (51) is locked to a side of the adjustment plate (50) away from the adjustment frame (30) by means of the third fasteners (52).

11. The assembly structure of the light unit (1) according to claim 10, wherein the combination plate (51) is provided with a third throughhole (510) corresponding to the second axial hole (500), wherein the combination plate (51) is provided with a plurality of third lockholes (511) corresponding to the second adjustment holes (501), wherein the third fasteners (52) pass through the third lockholes (511) and the second adjustment holes (501) to be locked to the second lockholes (321).

12. The assembly structure of the light unit (1) according to claim 10, wherein the combination plate (51) is further provided with a plurality of fixing holes (512) and a plurality of bolts (53), wherein the light unit (1) is passed through the fixing holes (512) to be combined to a fixed position by means of the bolts (53).

13. The assembly structure of the light unit (1) according to claim 1, wherein the light source (11) is exposed between the pair of supporting bases (20).
